(19) United States
(12) Patent Application Publication
(10) Pub. No.: US 2011/0320973 A1
(43) Pub. Date: Dec. 29, 2011

(54) METHOD AND ELECTRONIC DEVICE PROVIDING SCHEDULE MANAGEMENT

(75) Inventors: Tzu-Cheng YU, Santa Clara, CA (US); Jiing-Renn YU, Tu-Cheng (TW); Yu-Sheng HOU, Tu-Cheng (TW); Bor-Chuan LIN, Tu-Cheng (TW); Jian-Cheng LIN, Tu-Cheng (TW); El-Hinn ELIZABETH, Tu-Cheng (TW); Pei-Hsi CHENG, Tu-Cheng (TW); Hung-Chang WEI, Tu-Cheng (TW); Yun-Ju CHEN, Tu-Cheng (TW); Pei-Ju CHEN, Tu-Cheng (TW)

(73) Assignee: CHI MEI COMMUNICATION SYSTEMS, INC., Tu-Cheng City (TW)

(21) Appl. No.: 12/846,799

(22) Filed: Jul. 29, 2010

(30) Foreign Application Priority Data
Jun. 23, 2010 (TW) 99120537

(51) Int. Cl. G06F 3/048; G06F 15/16

(52) U.S. Cl. 715/772; 709/206

(57) ABSTRACT

An electronic device processes received messages, such as text messages, text-based emails, and push notifications, received by the electronic device. The electronic device extracts event information from the received messages. The electronic device enters the extracted event information in a calendar system of the electronic device.

### BACKGROUND

1. Technical Field

Embodiments of the present disclosure relate to user interfaces, and more particularly to a method and device providing schedule management

2. Description of Related Art

Short message systems (SMS) add convenience to mobile communications. However, if messages announcing or confirming scheduled events are received, the details thereof must still be transferred manually to a calendar/event schedule of the receiving device. Such a requirement is inconvenient, time consuming, and prone to user-based error.

### BRIEF DESCRIPTION OF THE DRAWINGS

FIG. 1 is a block diagram of one embodiment of an electronic device providing schedule management.

FIG. 2 is a flowchart illustrating one embodiment of a method for schedule management.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be integrated in firmware, such as an EPROM. It will be appreciated that module may comprise connected logic units, such as gates and flip-flops, and may comprise programmable units, such as programmable gate arrays or processors. The units described herein may be implemented as software and/or hardware unit and may be stored in any type of computer-readable medium or other computer storage device.

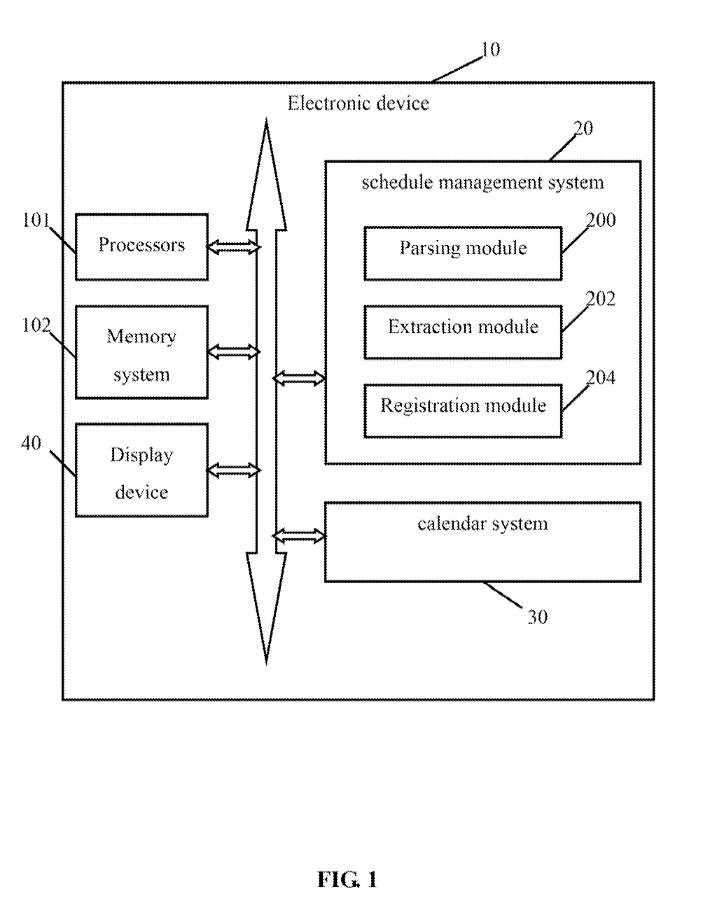

FIG. 1 is a block diagram of one embodiment of an electronic device 10 comprising a calendar system 30 and a schedule management system 20. The calendar system 30 is operable to schedule daily events and display a graphic calendar on a display device 40. The schedule management system 20 processes messages received by the electronic device 10 to extract event information of the messages. The schedule management system 20 enters the extracted event information into the calendar system 30. In the embodiment, the received messages are text-based and stored in the memory system 102. For example, the received messages can be simple text messages, text-based emails, or PUSH notifications. Depending on the embodiment, the electronic device 10 can be a mobile phone or PDA, for example.

The schedule management system 20 includes a parsing module 200 to parse the received messages, and an extraction module 202 to extract information, such as time and content, of the event from the parsed messages. The schedule management system 20 further includes a registration module 204 to register the extracted information to corresponding entries of the calendar system 30. The schedule management system 20 further comprises a setting interface to configure the schedule management system 20. One or more computerized codes of the modules 200-204 are stored in a memory system 102 and executed by one or more processors 101 of the electronic device 10.

In one embodiment, user can associate which media that carries the messages with the schedule management system 20. For example, email function is selected in the setting interface of the schedule management system 20, email received by the electronic device 10 is stored in the memory system 102 for processing.

In the embodiment, the parsing module 200 is operable to parse the received messages using standard syntax and grammar rules as a reference stored in the memory system 102 and can be modified via the setting interface of the schedule management system 20. The parsing module 200 identifies key parts of speech to deconstruct the received message.

For example, in a received exemplary text message reading, “Annie's birthday is tomorrow. We are going to throw her a surprise party. Care to join us?” is parsed, where since the first sentence contains the verb “is”, the parsing module 200 parses the first sentence as “Annie's birthday” and “tomorrow”. The parsing module 200 omits the verb “is” since it is likely not event-related. In the example, since the second sentence contains the verb phrase, “is going to”, the parsing module 200 parses the second sentence as “We”, “throw”, and “a surprise party!”. But since the verb “throw” needs an object according to the grammar rules, the parsing module 200 combines the section “throw” and “a surprise party” into “throw a surprise party”. In the example, since the third sentence contains the verb “care” and the infinitive “to join?”, the parsing module 200 parses the third sentence as “Care” and “to join”.

In the embodiment, the extraction module 202 is operable to extract event information from the parsed messages using punctuation marks, date rules, address rules, and prepositions, as a reference stored in the memory system 102. The extraction module 202 uses the date rules and address rules to identify dates and addresses in the received messages. It should be understood that the subject of the event often coincides with a date or address in the same sentence and the content of the event often comes along with the verb. In the example from paragraph 0012, in the first sentence, the extraction module 202 extracts “Annie's birthday” as the subject of the event since “tomorrow” is identifies as the date. In the second sentence, the extraction module 202 extracts “throw a surprise party” as the content of the event since the verb “throw” is a more event-related in the whole message. The extraction module 202 can omit pronouns since they are usually not event-related. In the third sentence, the extraction module 202 omits “Care” since the presence of the infinitive “to join?” The extraction module 202 omits the infinitive “to join?” since the question mark is identified.

In the embodiment, the registration module 204 registers the extracted event information to the identified date of the calendar system 30, if the extraction module 202 identifies the date from the parsed message. Otherwise, the registration module 204 registers the extracted contents to today's entry of the calendar system 30. In the example from paragraph 0013, the registration module 204 registers “Annie's birthday” and “throw a surprise party” to the entry of tomorrow of the calendar system 30.

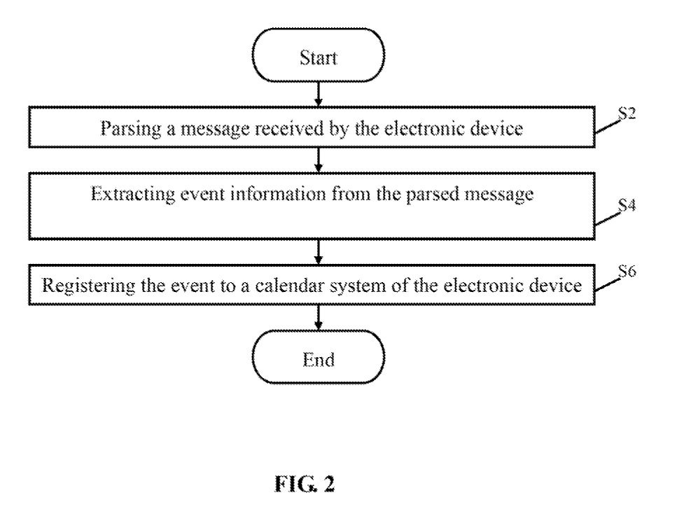

FIG. 2 is a flowchart of one embodiment of a method providing schedule management for an electronic device 10. Depending on the embodiments, additional blocks may be added, others removed, and the ordering of the blocks may be changed.

In block S2, a parsing module 200 parses the received messages using standard syntax and grammar rules. In block S4, the extraction module 202 extracts the event information from the parsed messages using the punctuation marks, date rules, address rules, and prepositions. In block S6, the registration module 204 registers the extracted event information to the entry of the extracted date of the calendar system 30.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a calendar system;
a memory system;
one or more processors; and
one or more programs stored in the memory system configured to be executed by the one or more processors, the one or more programs comprising:
a parsing module to parse messages received by the electronic device using standard syntax and grammar rules;
an extraction module to extract information of an event from the parsed messages; and
a registration module to register the extracted event information to the calendar system.

2. The device as claimed in claim 1, wherein the parsing module identifies at least one verb in the received messages.

3. The device as claimed in claim 1, wherein the extraction module uses date rules to identify date information of the event.

4. The device as claimed in claim 1, wherein the messages received by the electronic device are text-based.

5. The device as claimed in claim 3, wherein the registration module registers the extracted event information to the current day in the calendar system if the extraction module does not extract other date information of the event.

6. A computerized method of schedule management for an electronic device, comprising:
parsing messages received by the electronic device using standard syntax and grammar rules;
extracting information of an event from the parsed messages; and
registering the extracted event information to a calendar system of the electronic device.

7. The method as claimed in claim 6, wherein parsing identifies at least one verb of the received messages.

8. The method as claimed in claim 6, wherein the extraction uses date rules to identify date information of the event.

9. The method as claimed in claim 6, wherein the messages received by the electronic device are text-based.

10. The method as claimed in claim 8, wherein registration assigns the extracted event information to the current day in the calendar, if no date information of the event is extracted.

11. A computer readable storage medium having stored therein instructions, that when executed by an electronic device, cause the device to:
parse messages received by the electronic device using standard syntax and grammar rules;
extracting information of an event from the parsed messages; and
registering the extracted event information to a calendar system of the electronic device.

12. The computer readable storage medium as claimed in claim 11, wherein parsing identifies at least one verb of the received messages.

13. The computer readable storage medium as claimed in claim 11, wherein extraction uses date rules to identify date information of the event.

14. The computer readable storage medium as claimed in claim 11, wherein the messages received by the electronic device are text-based.

15. The computer readable storage medium as claimed in claim 13, wherein registration registers the extracted event information to the current day in the calendar system if no date information of the event is extracted.
